(19) United States
(12) Patent Application Publication
(10) Pub. No.: US 2006/0049316 A1
(43) Pub. Date: Mar. 9, 2006

(54) Operating method for launch rockets and a set of rocket boosters for carrying out said method

(76) Inventors: Sergey Vladimirovich Antonenko, Moscow (RU); Sergey Andreevich Belavskii, Ussuryskaya (RU)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/525,701

(22) PCT Filed: Aug. 20, 2003
(86) PCT No.: PCT/RU03/00372

§ 371 Date: Jul. 21, 2005

(30) Foreign Application Priority Data
Aug. 26, 2002 (CZ) PV 2002-2897

(51) Int. Cl. B64G 1/40

(52) U.S. Cl. 244/171.3

(57) ABSTRACT

The invention relates to the rocket and space engineering, and can find use in development of reusable rocket complexes for placing various space objects in orbit. A set of rocket boosters for operating launch vehicles comprises expendable and nonexpendable rocket boosters. A part of equipment of the expendable booster and a part of equipment of the nonexpendable boosters are replaceably mounted on said boosters and are capable to be interchangeable. A part of interchangeable equipment is made interconnected to another part of said equipment by at least a part of communications and structurally united into a module by a housing of a compartment of boosters. A method of operating launch vehicles comprises the steps of one-time using an expendable rocket booster within the launch vehicle, and reusing nonexpendable rocket boosters within the launch vehicles. There are the steps of periodical replacing a serviceable portion of the nonexpendable rocket booster (3, 4, 7) for a new one before repeated uses of the nonexpendable rocket booster, and mounting the replaced part onto the expendable rocket booster.

The invention relates to the rocket and space engineering, and can find use in development of reusable rocket complexes for placing various space objects in orbit.

Known from the technical literature (see: “Kosmomavtika Na Rubezhe Tysyachilety” (Cosmonautics At The Boundary of Millennia. Results And Prospects)—M.: Mashinostroenie/Mashinostroenie-Polyot (Machine Building/Machine Building-Flight) Publishers, 2001, pp. 325-327, 369-372) is a method of operating launch vehicles, said method comprising the steps of: one-time using expendable rocket boosters for the 2^{nd} stages within launch vehicles; and reusing nonexpendable rocket boosters for the 1^{st} stages within the same launch vehicles.

Known from the same reference is a set of rocket boosters for operating launch vehicles, comprising expendable and nonexpendable rocket boosters. The reference assumes the development of nonexpendable boosters at maximum use of already existing expendable rocket boosters.

The prior art method of operating launch vehicles has a number of disadvantages: a great number (up to 100) of cycles for functioning a nonexpendable booster resulting in the necessity to ensure a long service life and lifetime of its compartments, equipment and communications with respective increase in mass and in development, manufacture, test, and operation costs.

The prior art set of rocket boosters for operating launch vehicles has a number of disadvantages: significant distinctions inclusive of those arising due to significant differences of service life and resources among expendable and nonexpendable boosters in a design, a composition and arrangement of compartment housings, equipment, electrical, pneumatic, hydraulic and other communications; a low weight efficiency, a low reliability and safety, high costs of development, manufacture, testing and operating a expendable booster due to its required long service life and lifetime.

There are objects to be accomplished by the invention to provide a method and a set of rocket boosters for operating launch vehicles, said boosters allowing reduction of expenses for developing, testing and operating said launch vehicles with a respective reduction in the cost of placing various space objects in orbit.

It is another object of the invention to improve parameters of reliability and safety of functioning launch vehicles as a whole.

Said objects are accomplished by that, in a method of operating launch vehicles, comprising the steps of one-time using at least a part of at least one expendable rocket booster within at least one launch vehicle, and reusing at least a part of at least one nonexpendable rocket booster within at least one launch vehicle, ACCORDING TO THE INVENTION, there are the steps of replacing at least one serviceable part of at least one nonexpendable rocket booster for a new one before at least one repeated use of the at least one nonexpendable rocket booster, and mounting the replaced part onto at least one expendable rocket booster. The step of mounting the replaced part onto the at least one expendable rocket booster is performed before each use of said booster within the at least one launch vehicle during at least two launches of the latter. The replacing step is performed for a part having the least remaining lifetime. The replacing step is performed for a part having the least remaining service life. There is the step of storing the at least one replaced part before the step of mounting the same. There is the step of using at least one part of at least one nonexpendable rocket booster within at least two different launch vehicles.

The aforementioned technical objects are accomplished also by that, in a set of rocket boosters for operating launch vehicles, having at least one expendable rocket booster and at least one nonexpendable rocket booster, ACCORDING TO THE INVENTION, at least one part of equipment of the expendable booster and at least one part of equipment of the nonexpendable booster are replaceably mounted on said boosters and are capable to be interchangeable. At least a part of interchangeable equipment is made interconnected to another part of said equipment by at least a part of communications and structurally united into at least one interchangeable module by at least a part of a housing of at least one compartment of a booster. At least a part of the interchangeable equipment of said rocket boosters is capable of being mounted onto at least one launch vehicle. At least a part of the interchangeable equipment of said rocket boosters is capable of being mounted onto at least two different launch vehicles.

The invention will no be described with reference to the accompanying drawings where

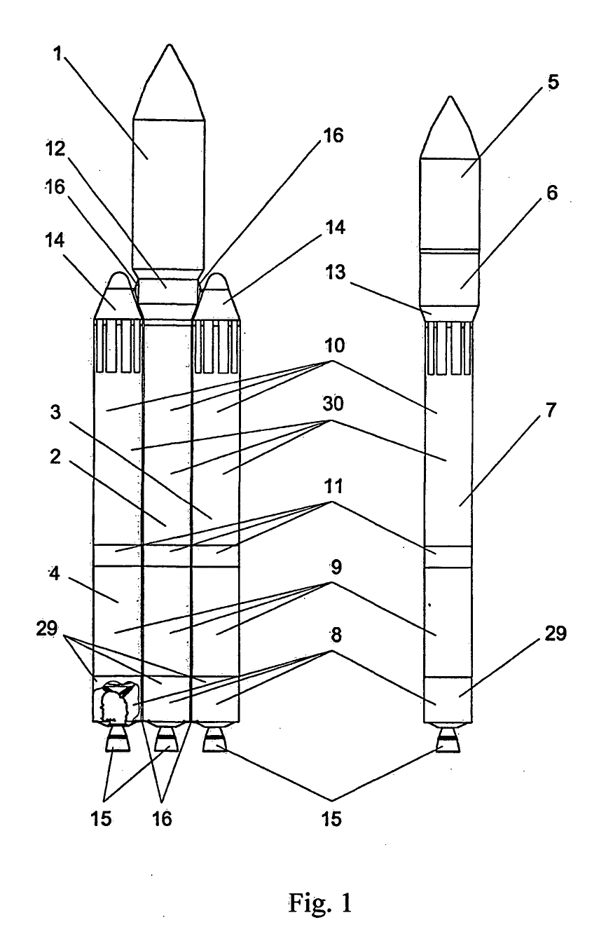

FIG. 1 shows general views of launch vehicles, nonexpendable and expendable rocket boosters.

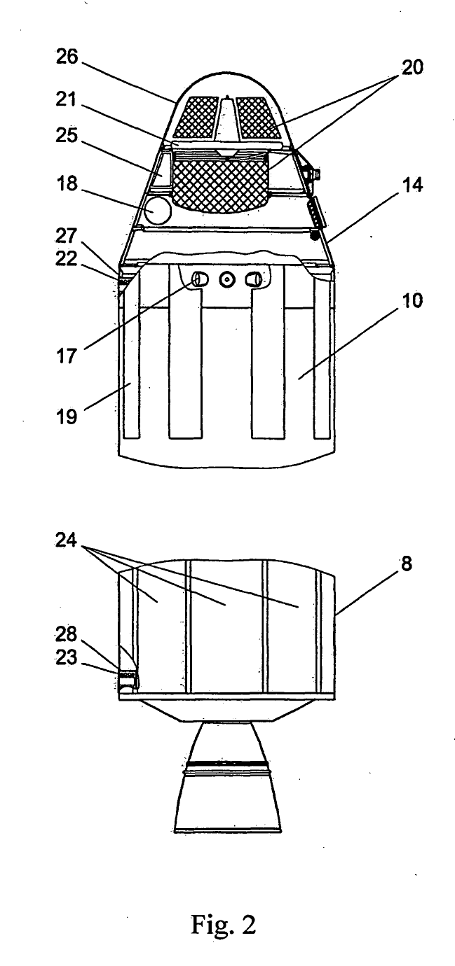

FIG. 2 illustrates an arrangement embodiment of means for returning a nonexpendable rocket booster.

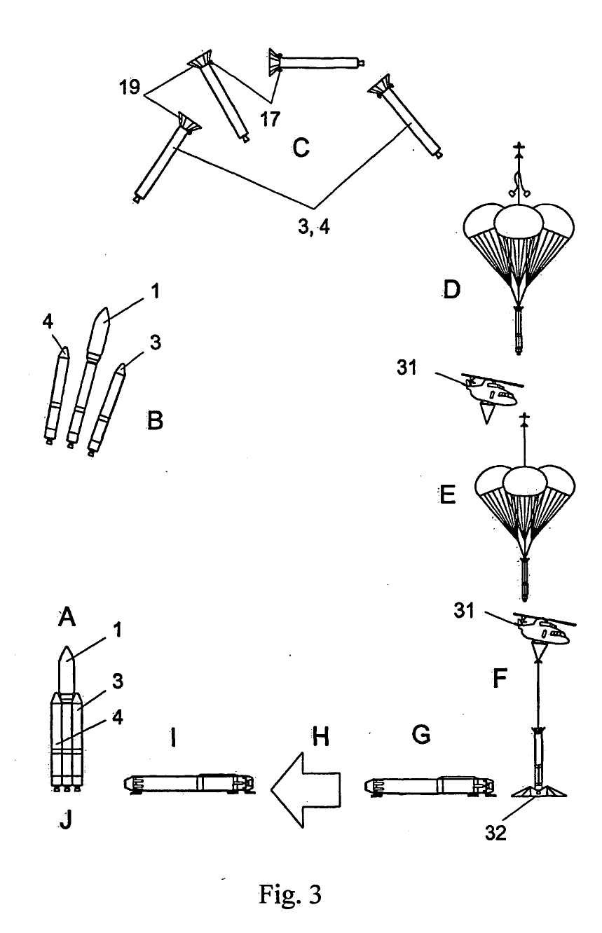

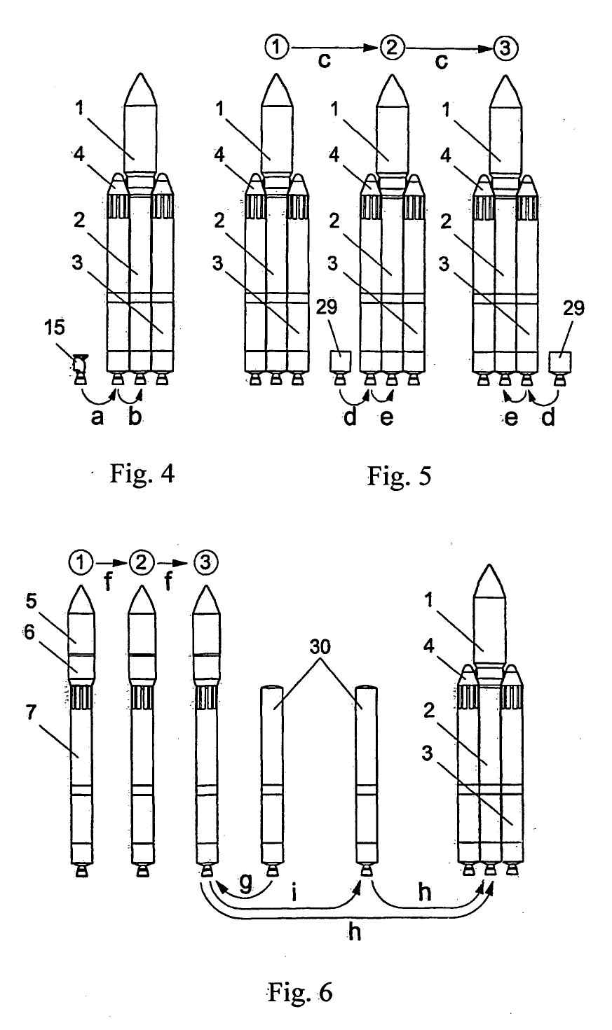

FIG. 3 shows a diagram that exemplifies functionality of a nonexpendable rocket booster. Some other versions of schemes for operating launch vehicles are shown in FIGS. 4, 5, 6.

A set of rocket boosters for operating, for example, a launch vehicle 1 comprises, for example, one expendable rocket booster 2 and, for example, two nonexpendable rocket boosters 3, 4 (see FIG. 1).

For example, a set of rocket boosters for operating a launch vehicle 5 comprises, for example, one expendable rocket booster 6 and, for example, one nonexpendable rocket booster 7 (see FIG. 1).

For example, the boosters 2, 3, 4 are capable of being mounted onto the launch vehicle 1 (see FIG. 1).

For example, the booster 7 is capable of being mounted onto the launch vehicle 5 (see FIG. 1).

For example, the boosters 3, 4, 7 fulfill functions of boosters for the 1^{st} stages, respectively, of the launch vehicles 1 and 5 (see FIG. 1).

The booster 2 fulfills, for example, functions of a booster for the 2^{nd} stage of the launch vehicle 1 (see FIG. 1).

The booster 6 fulfills, for example, functions of a booster for the 2^{nd} stage of the launch vehicle 5 (see FIG. 1).

A number of both the expendable and nonexpendable boosters within the launch vehicles 1, 5 may vary depending on a required load-carrying capacity and adopted schemes for launching the launch vehicles 1, 5 (see FIG. 1).

For example, the boosters 2, 3, 4, 7 comprise housings of compartments wherein equipment is mounted, for example (see FIG. 1):
tail compartments 8;
tank compartments 9 and 10;
inter-tank compartments 11.

Additionally, the booster 2 comprises, for example, an intermediate compartment 12, the booster 7 comprises, for example, intermediate compartment 13, and the boosters 3, 4 comprise, for example, fore compartments 14 (see FIG. 1).

Equipment required for functionality of the boosters 2, 3, 4 within the launch vehicles 1, 5, for example, units of the sustainer propulsion system (sustainer engines 15 with units of a pneumatic and hydraulic system), means for providing thermal conditions and fire control, instruments for control systems, terrestrial measurements and telemetry monitoring, sensor devices (see FIG. 1) can be mounted on housings of compartments 8, 9, 10, 11, 12, 13, 14. Equipment of the boosters 2, 3, 4, 7 is interconnected by electrical, pneumatic, hydraulic, and other communications made, for example, as electrical cables, conduits, and others (see FIG. 1).

The boosters 2, 3, 4 can be united within the launch vehicle 1 by inter-booster connections 16 mounted, for example, in the intermediate compartment 12, the fore compartments 14, and the tail compartments 8 (see FIG. 1).

The boosters 3, 4, 7 can be provided with means having different compositions and designs and being designed for returning to a cosmodrome.

Thus, the means for returning, for example, the boosters 3, 4 may include, for example (see FIG. 2):
orientation means made as nozzles 17 of jet control systems 18;
passive stabilization means made as pivoted flaps 19;
parachute systems 20;
gripping-enabling means 21;
landing-enabling means made, for example, as landing ropes 22, 23;
thermal protection means for the tail compartments 8, made, for example, as removable panels 24;
on-board return control complexes 25.

A portion of the return means for the boosters 3, 4 can be mounted on housings of their fore compartments 14 (see FIG. 2):
the parachute systems 20 and the gripping-enabling means 21 can be mounted for example, beneath of cones 26 of housings of the fore compartments 14;
the landing ropes 22, the units and instruments of the jet control systems 18 and of the on-board return control complexes 25 can be mounted for example, inside of the housings of the fore compartments 14;
the flaps 19 and the jet nozzles 17 can be mounted, for example, on an external surface of the housings of the fore compartments 14;
the landing ropes 22 can be mounted, for example, in recesses 27 of the housings of the fore compartments 14.

A portion of the return means for the boosters 3, 4 can be mounted on housings of the tail compartments 8 (see FIG. 2):
the removable panels 24 can be mounted, for example, on the external surface of the housings of the tail compartments 8;
the landing ropes 23 can be mounted, for example, in recesses 28 of the housings of the tail compartments 8.

The booster 7 can be provided with the return means identical to said return means for the boosters 3, 4 (see FIG. 2).

Parts of equipment of the boosters 2, 3, 4, 7, for example, their sustainer engines 15 can be replaceably and interchangeably mounted (see FIG. 1).

Parts of equipment of the boosters 2, 3, 4, 7, for example, sustainer engines 15 with a portion of units of the pneumatic-hydraulic system can be coupled, for example, by hydraulic communications and can be structurally united by the housings of the tail compartments 8, for example, into tail interchangeable modules 29 replaceably mounted on the boosters 2, 3, 4, 7 (see FIG. 1).

Parts of equipment of the boosters 2, 3, 4, 7, for example units of the sustainer propulsion system (sustainer engines 15 with units of the pneumatic and hydraulic system), means for maintaining thermal conditions and fire control, instruments for control systems, terrestrial measurements and telemetry monitoring, sensor devices, and others, can be made interconnected by electrical, pneumatic, hydraulic, and other communications and structurally united by the housings of the compartments 8, 9, 10, 11, for example, into interchangeable rocket modules 30 replaceably mounted on the boosters 2, 3, 4, 7 (see FIG. 1).

During reuse of the nonexpendable boosters 2, 3, 4, 5, 7, possible are different schemes of their functioning.

Thus, a scheme of functioning of, for example, the boosters 3, 4 can include the following steps (see FIG. 3):
A—launching the boosters 3, 4 within the launch vehicle 1;
B—detaching the spent boosters 3, 4 from the launch vehicle 1;
C—ballistic flying the boosters 3, 4 in the upper atmosphere layers;
D—parachute-aided braking the boosters 3, 4 in the dense atmosphere layers;
E—gripping the parachuting boosters 3, 4 by rescue helicopters 31;
F—helicopter-aided landing the boosters 3, 4 onto a prepared pad 32;
G—post-flight maintenance of the boosters 3, 4;
H—hauling the boosters 3, 4 to a launch cosmodrome;
I—preparing the boosters 3, 4 to repeated use;
J—repeated launching said boosters within the launch vehicle 1.

The steps C, D, E, F, G, H (see FIG. 3) are the constituents of the process of returning the boosters 3, 4 to a launch cosmodrome.

It is possible to detach the boosters 3, 4 from a launch vehicle when they complete to fulfill upon completion of fulfillment of their functions, for example, after the rocket fuel components' stock in the sustainer propulsion system 15 has been spent (see FIG. 1).

During the ballistic flight of the boosters 3, 4 in the upper atmosphere layers, it would be reasonable to provide reduction in a spread of path parameters and in effective loads. To this end, the boosters 3, 4 can be oriented, for example, using the jet nozzles 17 of the jet control system 18, and they can be, for example, passively stabilized and preliminarily braked using the pivoted flaps 19 (see FIGS. 2, 3). At the same time, the panel 24 can provide the protection of the tail compartments' 8 structures against thermal effects (see FIGS. 2, 3).

The pad 32 prepared for helicopter-aided landing the boosters 3, 4 can be located, for example, in vicinity of a railway, an aerodrome, a river port or a seaport. Further, the pad can be located, for example, on board of river- or sea-going ships and be advanced to the gripping area a certain time period ahead of the launch of the launch vehicle 1.

The transportation of the boosters 3, 4 a cosmodrome is possible by railway, aircraft, river, sea, automobile, and other means of transportation.

During preparation of the boosters 3, 4 for repeated use, diagnostics of their conditions can be carried out. To simplify the diagnostics, on-board return control complexes 25 for the boosters 3, 4 can be equipped, for example, with means for recording and storing data pertaining to external factors that act to the boosters during their operation.

Upon diagnostics of condition of the boosters 3, 4, their unserviceable (out-of-order, with expired service life, with completed lifetime) equipment and structural components can be replaced.

A scheme of functioning the booster 7 can be similar to the above-mentioned one of the boosters 3, 4 (see FIG. 3).

Also possible is a mode of operating the launch vehicle 1 (see FIG. 4), for example, comprising—prior to a regular repeated use of the booster 3 within the launch vehicle 1—the steps of: replacing a part of the booster 3 equipment having the least remaining lifetime and/or service life, for example, the sustainer engine 15, for a new serviceable part prior to a next repeated use of the booster 3 within the launch vehicle 1 (FIG. 4 schematically shows the process of replacing the sustainer engine 15 for a new one by arrow “a”); and mounting the replaced sustainer engine 15 is mounted onto the booster 2 (FIG. 4 schematically shows the process of mounting the replaced sustainer engine 15 onto the booster 2 by arrow “b”). The replacement of the sustainer engine 15 of the booster 3 for a new one allows extension of the lifetime and/or service life of the booster 3 as a whole, while the mounting of the replaced sustainer engine 15 onto expendable booster 2 allows reduction of costs for extending the lifetime and/or service life of booster 3. However, such replacement and mounting of the sustainer engines 15 require a large amount and labor-intensive works for coupling/uncoupling mechanical, pneumatic, hydraulic, electrical, and other connections of the sustainer engines 15 to/from the compartment housings and equipment of the boosters 2, 3.

Also possible is a mode of operating the launch vehicle 1 (see FIG. 5), for example, comprising—prior to each repeated use of the booster 2 within the launch vehicle 1, for example, during two launches of launch vehicle 1, starting, for example, from the second launch (FIG. 5 schematically shows launches of the launch vehicle 5 by arrows “c” while a serial number of a launch is denoted by a digit within a circle)—the steps of: replacing, for example, the serviceable tail module 29 of one of the boosters 3, 4 for a new one (FIG. 5 schematically shows the process of replacing the tail module 29 for a new one by arrows “d”), and mounting the replaced tail module 29 onto the booster 2 (FIG. 5 schematically shows the process of mounting the replaced tail module 29 onto the booster 2 by arrows “e”). In doing so, if the tail modules 29 of the boosters 3, 4 have different remaining lifetime and/or service life, then, there is the step of replacing a tail module 29 having the least remaining lifetime and/or remaining service life. Such operation of the launch vehicle 1 allows limitation of the required lifetime and/or service life of the tail modules 29 to values ensuring a relatively low multiplicity of their use (e.g., triple use in this case:) without any decrease in the economical efficiency afforded by reuse. Furthermore, implementation of the replaceable equipment of the nonexpendable boosters 3, 4 in the form of the interchangeable tail modules 29 allows reduction in labor intensiveness of the works for coupling/uncoupling mechanical, pneumatic, hydraulic, electrical, and other connections caused by the scheduled regular replacements and mountings of equipment of the boosters 3, 4.

Also possible is a mode of operating two launch vehicles 1, 5 (see FIG. 6), for example, comprising—after triple use of the rocket booster 7 within the launch vehicle 5 (FIG. 6 schematically shows launches of the launch vehicle 5 by arrows “f”, and a serial number of a launch is denoted by a digit within a circle)—the steps of: replacing the serviceable rocket module 30 of the booster 7, for example, for a new one (FIG. 6 schematically shows the process of replacing the rocket module 30 for a new one by arrow “g”); and mounting the replaced rocket module 30 onto the booster 2 of the launch vehicle 1 (FIG. 6 schematically shows the process of mounting the replaced rocket module 30 onto the booster 2 by arrows “h”). At the same time, to ensure the versatile use of the launch vehicles 1, 5, it is possible to store the replaced rocket module 30 prior to mounting it onto the booster 2 of the launch vehicle 1 (FIG. 6 schematically shows the process of storing the replaced rocket module 30 by arrow “i”). Such a way of operating the launch vehicles 1, 5 allows extension of the lifetime and/or service life of the booster 7 as a whole; and the mounting of the replaced rocket module 30 onto the expendable booster 2 under of these circumstances allows essential reduction in costs for extension of the lifetime and/or service life of the booster 7. Besides, implementation of the replaceable equipment of the nonexpendable rocket boosters 3, 4, 7 in the form of interchangeable rocket modules 30 enables minimization of labor intensiveness of the works for coupling/uncoupling mechanical, pneumatic, hydraulic, electrical, and other connections, which works are caused by the scheduled regular replacements and mountings of equipment of the rocket boosters 3, 4, 7.

Also possible are embodiments of the method of operating the launch vehicles 1, 5 that are based, for example, on combinations of the above-mentioned schemes of operating (see FIGS. 4, 5, 6).

Thus, the method and the set of rocket boosters for operating, for example, the launch vehicles 1, 5, as described herein, allow:
actual attainment of the maximum economical efficiency (theoretically feasible only in case of using indefinitely reusable rocket boosters) owing to repeated use of the equipment and structures of the nonexpendable boosters 3, 4, 7, with a relatively small required multiplicity of their use (e.g., in triple use—see FIG. 5);
limitation of the required lifetime and/or service life of the equipment and structures of the nonexpendable boosters 3, 4, 7 to the values ensuring the required multiplicity of their use;
reduction in mass of the equipment and structural members of boosters 3, 4, 7 owing to limiting their required lifetime and/or service life;
improvement in reliability and safety of functioning of the launch vehicles 1, 5 as a whole owing to a diminished multiplicity of using the equipment and structures of the nonexpendable boosters 3, 4, 7;
bringing the required lifetimes and/or service lives of the equipment and members of structures of expendable and nonexpendable boosters closer to each other, so as to provide the possibility for collating the processes of developing, manufacturing and testing the boosters 2, 3, 4, 7;
minimization of labor intensiveness of the works for coupling/uncoupling mechanical, pneumatic, hydraulic, electrical, and other connections performed according to the scheduled regular replacements of equipment of the rocket boosters 3, 4, 7 and mountings of the replaced equipment onto the rocket booster 2.

1. A method of operating launch vehicles, comprising the steps of:
one-time using at least a part of at least one expendable rocket booster within at least one launch vehicle;
reusing at least a part of at least one nonexpendable rocket booster within at least one launch vehicle; and
replacing at least one serviceable part of at least one nonexpendable rocket booster for a new one before at least one repeated use of the at least one nonexpendable rocket booster; and
mounting the replaced part onto at least one expendable rocket booster.

2. The method of operating the launch vehicles as claimed in claim 1, further including mounting the replaced part onto the at least one expendable rocket booster before each use of said booster within the at least one launch vehicle during at least two launches of the latter.

3. The method of operating the launch vehicles as claimed in claim 1, further including replacing a part having the least remaining lifetime.

4. The method of operating the launch vehicles as claimed in claim 1, further including replacing a part having the least remaining service life.

5. The method of operating the launch vehicles as claimed in claim 1, further including storing the at least one replaced part before the step of mounting the same.

6. The method of operating the launch vehicles as claimed in claim 1, further including using at least one part of at least one nonexpendable rocket booster within at least two different launch vehicles.

7. A set of rocket boosters for operating launch vehicles, having at least one expendable rocket booster and at least one nonexpendable rocket booster, wherein at least one part of equipment of the expendable booster and at least one part of equipment of the nonexpendable booster are replaceably mounted on said boosters and are capable to be interchangeable.

8. A set of rocket boosters for operating launch vehicles as claimed in claim 7, wherein at least a part of interchangeable equipment is made interconnected to another part of said equipment by at least a part of communications and structurally united into at least one interchangeable module by at least a part of a housing of at least one compartment of a booster.

9. A set of rocket boosters for operating the launch vehicles as claimed in claim 7, wherein at least a part of the interchangeable equipment of said rocket boosters is capable of being mounted onto at least one launch vehicle.

10. A set of rocket boosters for operating the launch vehicles as claimed in claim 7, wherein at least a part of the interchangeable equipment of said rocket boosters is capable of being mounted onto at least two different launch vehicles.
